(19) United States
(12) Patent Application Publication
(10) Pub. No.: US 2022/0075249 A1
(43) Pub. Date: Mar. 10, 2022

(54) METHOD AND APPARATUS FOR CONTROLLING FOCUSING ASSEMBLY, FOCUSING ASSEMBLY, AND PROJECTOR

(71) Applicant: IVIEW DISPLAYS (SHENZHEN) COMPANY LTD., Shenzhen (CN)

(72) Inventors: Xinyong Zhang, Shenzhen (CN); Steve Yeung, Hong Kong (CN); Zhiqiang Gao, Hong Kong (CN); Leiming Ji, Shenzhen (CN); Augustus Yeung, Hong Kong (CN); Mingnei Ding, Shenzhen (CN)

(21) Appl. No.: 17/530,796

(22) Filed: Nov. 19, 2021

Related U.S. Application Data
(63) Continuation of application No. PCT/CN2019/129569, filed on Dec. 28, 2019.

(30) Foreign Application Priority Data
Nov. 5, 2019 (CN) 201911072023.2

(51) Int. Cl. G03B 21/53; G03B 21/14; G02B 7/28

(52) U.S. Cl. CPC G03B 21/53; G02B 7/28; G03B 21/142

(57) ABSTRACT

The present disclosure relates to the technical field of digital projection and display, and in particular, relates to a method for controlling a focusing assembly. The focusing assembly includes a lens module, a motor, a bevel retaining piece, and a photoelectric switch. The photoelectric switch includes an optical transmitter and an optical receiver that are oppositely disposed, the motor is connected to the lens module. The method includes: receiving a current voltage signal from the photoelectric switch; determining a current position of the lens module based on the current voltage signal; controlling the motor to stop driving the lens module in response to the current position of the lens module being the predetermined position.

### CROSS-REFERENCE TO RELATED APPLICATIONS

This application is a continuation of International Patent Application NO. PCT/CN2019/129569, which is based upon and claims priority to Chinese Patent Application No. 2019110720232, filed before China National Intellectual Property Administration on Nov. 5, 2019 and entitled “METHOD AND APPARATUS FOR CONTROLLING FOCUSING ASSEMBLY, FOCUSING ASSEMBLY, AND PROJECTOR,” the entire contents of which are incorporated herein by reference.

### TECHNICAL FIELD

Embodiments of the present disclosure relate to the technical field of digital projection and display, and in particular, relate to a method for controlling a focusing assembly, a focusing assembly, and a projector.

### BACKGROUND

With the development of the semiconductor technology and the improvement of integration, a projector may be made even smaller in size. However, the reduction of the size of the projector reduces space available in the projector, such that a focusing assembly in the projector may be equipped with only one photoelectric switch to detect the movement of a lens module. In the case that one photoelectric switch is provided to detect the movement of the lens module, the detection is conducted mainly by using a voltage signal generated by the photoelectric switch.

At present, a photoelectric switch is triggered, by using a rectangular retaining piece, to generate a voltage signal.

### SUMMARY

One technical solution employed by the embodiments of the present disclosure is a method for controlling a focusing assembly, wherein the focusing assembly includes a lens module, a motor, a bevel retaining piece, and a photoelectric switch, the photoelectric switch including an optical transmitter and an optical receiver, the optical transmitter and the optical receiver being oppositely disposed, the motor being connected to the lens module and configured to drive the lens module to move, the bevel retaining piece being in movement relative to the photoelectric switch in the case that the lens module is moving, wherein an optical field between the optical transmitter and the optical receiver is positioned on a relative movement path of the bevel retaining piece, and in the case that the bevel retaining piece is moving in the optical field, the bevel retaining piece changes a receive amount of the optical receiver, and the photoelectric switch generates a voltage signal based on the receive amount; and

the method includes:

receiving a current voltage signal from the photoelectric switch;

determining a current position of the lens module based on the current voltage signal;

determining whether the current position of the lens module is a predetermined position; and

controlling the motor to stop driving the lens module in response to the current position of the lens module being the predetermined position.

Another technical solution employed by the embodiments of the present disclosure is a focusing assembly. The focusing assembly includes:

a lens module;

a bevel retaining piece;

a photoelectric switch, wherein the photoelectric switch includes an optical transmitter and an optical receiver, the optical transmitter and the optical receiver being oppositely disposed; and

a motor, wherein the motor is connected to the lens module and configured to drive the lens module to move, and the bevel retaining piece is in movement relative to the photoelectric switch in the case that the lens module is moving, wherein an optical field between the optical transmitter and the optical receiver is positioned on a relative movement path of the bevel retaining piece, and in the case that the bevel retaining piece is moving in the optical field, the bevel retaining piece changes a receive amount of the optical receiver, and the photoelectric switch generates a voltage signal based on the receive amount.

Another technical solution employed by the embodiments of the present disclosure is a projector. The projector includes:

the focusing assembly as described above; and

a control unit, wherein the control unit is connected to the focusing assembly;

wherein the control unit includes at least one processor, and

a memory communicably connected to the at least one processor;

wherein the memory stores at least one instructions executable by the at least one processor, wherein the at least one instruction, when executed by the at least one processor, causes the at least one processor to perform the method for controlling the focusing assembly.

Another technical solution employed by the embodiments of the present disclosure is a non-volatile computer readable storage medium, wherein the non-volatile computer readable storage medium stores one or more computer executable instructions, which, when being executed by a computer, cause the computer to perform the method as described above.

### BRIEF DESCRIPTION OF THE DRAWINGS

One or more embodiments are illustrated by way of example, and not by limitation, in the figures of the accompanying drawings, wherein components having the same reference numeral designations represent like components throughout. The drawings are not to scale, unless otherwise disclosed.

FIG. 1 is a schematic diagram of variations of a shielding area in the case that a rectangular retaining piece moves in an optical field of a photoelectric switch;

FIG. 2 is a waveform diagram of a voltage signal generated by the photoelectric switch under triggering by the rectangular retaining piece;

FIG. 3 is a schematic structural diagram of a projector according to an embodiment of the present disclosure;

FIG. 4 illustrates a front view and a right view of a focusing assembly according to an embodiment of the present disclosure;

FIG. 5 is a cross-sectional view of the focusing assembly illustrated in FIG. 4 in an A-A direction;

FIG. 6 is a schematic diagram of variations of a shielding area in the case that a bevel retaining piece moves in an optical field of the photoelectric switch;

FIG. 7 is a waveform diagram of a voltage signal generated by the photoelectric switch under triggering by the bevel retaining piece which moves in one movement direction;

FIG. 8 is a waveform diagram of a voltage signal generated by the photoelectric switch under triggering by the bevel retaining piece which moves in another movement direction;

FIG. 9 is a schematic flowchart of a method for controlling a focusing assembly according to an embodiment of the present disclosure;

FIG. 10 is a schematic structural diagram of an apparatus for controlling a focusing assembly according to an embodiment of the present disclosure;

FIG. 11 is a schematic structural diagram of an apparatus for controlling a focusing assembly according to another embodiment of the present disclosure; and

FIG. 12 is a schematic hardware structural diagram of a control unit according to an embodiment of the present disclosure.

### DETAILED DESCRIPTION

For clearer descriptions of the objects, technical solutions, and advantages of the embodiments of the present disclosure, the following clearly and completely describes the technical solutions in the embodiments of the present disclosure with reference to the accompanying drawings in the embodiments of the present disclosure. Apparently, the described embodiments are merely a part rather than all of the embodiments of the present disclosure. Based on the embodiments of the present disclosure, all other embodiments derived by persons of ordinary skill in the art without any creative efforts shall fall within the protection scope of the present disclosure.

It should be noted that, when an element is defined as “being secured or fixed to” another element, the element may be directly positioned on the element or one or more centered elements may be present therebetween. When an element is defined as “being connected or coupled to” another element, the element may be directly connected or coupled to the element or one or more centered elements may be present therebetween. As used herein, the terms “vertical,” “horizontal,” “left,” “right,” and similar expressions are for illustration purposes.

In addition, technical features involved in various embodiments of the present disclosure described hereinafter may be combined as long as these technical features are not in conflict.

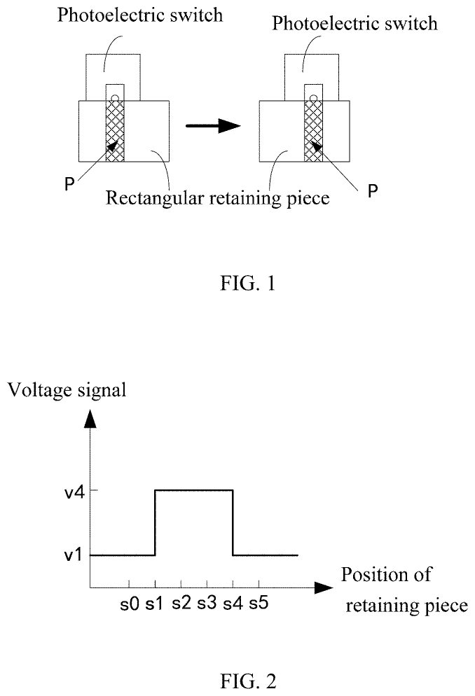

The inventors have found that during practice of the present disclosure: when the rectangular retaining piece is used to trigger the photoelectric switch to generate the voltage signal, a shielding area remains unchanged (P in FIG. 1 is the shielding area) in the case that the rectangular retaining piece relatively is moving in an optical field of the photoelectric switch, and a receive amount of an optical receiver of the photoelectric switch may not be changed, such that the voltage signal of the photoelectric switch remains unchanged in the case that the rectangular retaining piece is moving in the optical field. Therefore, the voltage signal of the photoelectric switch jumps only when the rectangular retaining piece enters or leaves the optical field (as illustrated in FIG. 2). Based on this, in the case that the movement of the lens module is detected based on the voltage signal triggered by the rectangular retaining piece, the position of the lens module when the rectangular retaining piece enters or leaves the optical field may only be determined, and the focusing accuracy is poor.

Embodiments of the present disclosure provide a method and apparatus for controlling a focusing assembly. The method and the apparatus are applicable to a projector, such that the projector is capable of determining a current position of a lens module based on a current voltage signal generated by a photoelectric switch under triggering by a bevel retaining piece, and controlling a motor to stop driving the lens module in response to the current position of the lens module being a predetermined position. A real-time position of the lens module may be determined during the movement of the bevel retaining piece in an optical field based on the voltage signal generated by the photoelectric switch under triggering by the bevel retaining piece. Based on this, in the case that the predetermined position is any real-time position of the lens module, whether the lens module reaches the predetermined position is determined based on the current position of the lens module, such that the lens module may be stopped at any real-time position, and focusing accuracy is improved.

Hereinafter, the present disclosure is further described with reference to some specific embodiments.

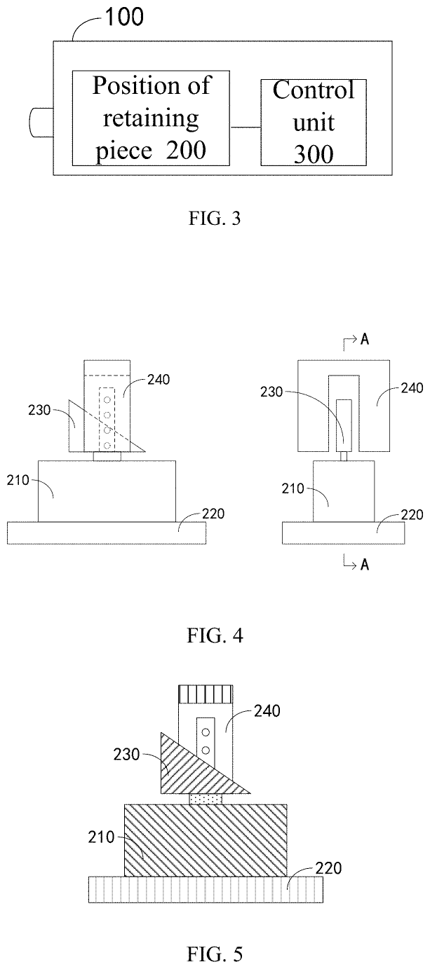

Referring to FIG. 3, a schematic structural diagram of a projector according to an embodiment of the present disclosure is illustrated. The projector includes a body 100, a focusing assembly 200 and a control unit 300, wherein the focusing assembly 200 and the control unit 300 are mounted in the body 100, and the control unit 300 is communicatively connected to the focusing assembly 200.

Specifically, the body 100 is provided with a projection lens, and the projector projects projection content via the projection lens. In the case that the focusing assembly 200 is mounted in the body 100, the focusing assembly 200 and the projection lens are arranged opposite to each other, such that a projection focal length of the projection lens may be changed via the focusing assembly 200.

The body 100 is further provided with a control panel. The projector interacts with a user via the control panel, wherein interaction includes receiving a trigger signal triggered by the user via the control panel. In the case that the control unit 300 is mounted in the body 100, the control unit 300 is communicatively connected to the control panel, such that the trigger signal may be received from the control panel. In an embodiment of the present disclosure, the control panel includes a focusing button, wherein a focusing signal triggered by the user may be received via the focusing button.

The control panel may be a touch screen or a physical keyboard.

Referring to FIG. 4 and FIG. 5, the focusing assembly 200 includes a lens module 210, a motor 220, a bevel retaining piece 230, and a photoelectric switch 240.

The lens module 210 is composed of a number of lenses. An optical axis of the lens module 210 is coincident with an optical axis of the projection lens, and the lens module 210 is capable of moving back and forth along the optical axis to be close to/away from the projection lens.

The focusing assembly 200 changes the projection focal length of the projection lens by changing a relative distance between the lens module 210 and the projection lens.

The motor 220 is a linear motor, wherein the linear motor is connected to the lens module 210 and configured to drive the lens module 210 to move along the optical axis.

The bevel retaining piece 230 is a sheet-like structure, and a cross section of the bevel retaining piece 230 is rectangular in a thickness direction. In some embodiments, the cross section of the bevel retaining piece 230 in the thickness direction may be trapezoidal.

The bevel retaining piece 230 is opaque.

The photoelectric switch 240 includes an optical transmitter and an optical receiver, wherein the optical transmitter and the optical receiver are oppositely disposed, and the optical transmitter is configured to emit infrared light to the optical receiver, to form an optical field between the optical transmitter and the optical receiver.

Optionally, the photoelectric switch 240 is a groove-type photoelectric switch.

In an embodiment of the present disclosure, the bevel retaining piece 230 is fixed on the lens module 210, and the photoelectric switch 240 is arranged on a movement path of the lens module 210 and fixedly mounted on an inner wall of the body 100. The bevel retaining piece 230 is in movement relative to the photoelectric switch 240 in the case that the lens module 210 is moving, and the optical field between the optical transmitter and the optical receiver of the photoelectric switch 240 is positioned on a relative movement path of the bevel retaining piece 230, that is, the bevel retaining piece 230 travels through the optical filed of the photoelectric switch 240 in response to moving relative to the photoelectric switch 240.

In the case that the bevel retaining piece 230 is moving in the optical field of the photoelectric switch 240, side walls in the thickness direction of the bevel retaining piece 230 face the optical transmitter and the optical receiver respectively, that is, the side walls in the thickness direction of the bevel retaining piece 230 are the shielding surfaces, wherein the shielding surfaces are triangular. In some embodiments, the shielding surface may also be trapezoidal.

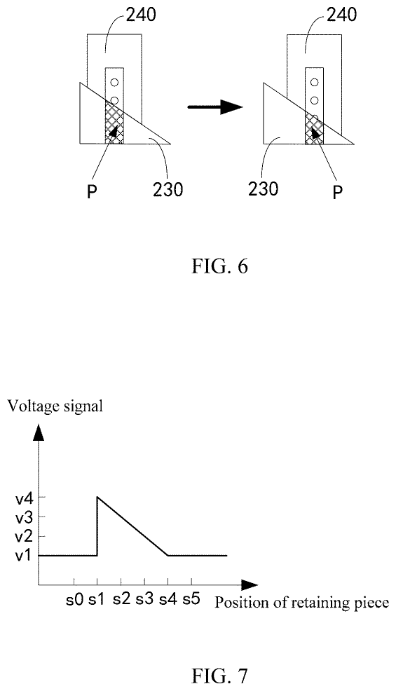

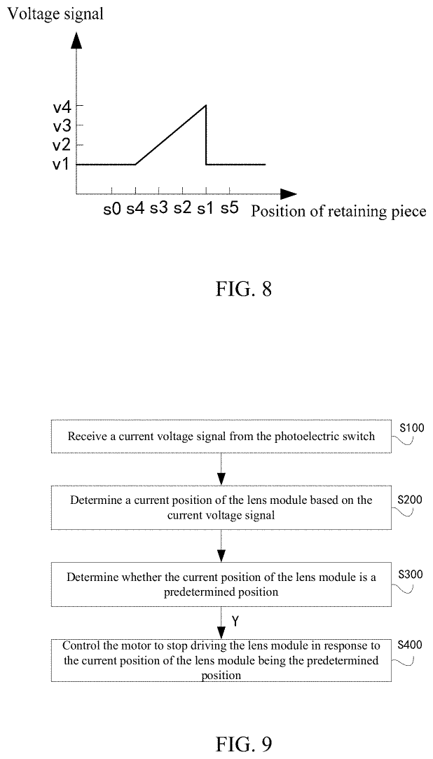

Since the shielding surface of the bevel retaining piece 230 is triangular, in the case that the bevel retaining piece 230 is moving to different positions in the optical field of the photoelectric switch 240, shielding areas of the shielding surfaces shielding the infrared light in the optical field are different (as illustrated in FIG. 6), such that receive amounts of the optical receiver are different, and further the photoelectric switch 240 generates different voltage signals (as illustrated in FIG. 7 and FIG. 8) based on the different receive amounts, that is, different voltage signals correspond to different positions of the bevel retaining piece 230. Based on this, a real-time position of the bevel retaining piece 230 in the optical filed may be determined based on the voltage signal generated by the photoelectric switch 240 in the case that the bevel retaining piece 230 is moving in the optical field of the photoelectric switch 240. Since the bevel retaining piece 230 is fixed on the lens module 210, a real-time position of the lens module 210 may be determined based on the real-time position of the bevel retaining piece 230.

Since the position of the lens module 210 may only be determined in the case that the bevel retaining piece 230 is in the optical field, in order to accurately control the lens module 210 and prevent the lens module 210 from running out of an effective stroke, the effective stroke of the lens module 210 is set in the range where the bevel retaining piece 230 is moving in the optical field. That is, the effective stroke of the lens module 210 is set within a position range that may be determined by the voltage signal.

Further, in the case that the shielding surface of the bevel retaining piece 230 is triangular, where the movement direction of the bevel retaining piece 230 varies, a variation regulation of the shielding area varies accordingly, such that the voltage signal produces different variation regulations (as illustrated in FIG. 7 and FIG. 8). Based on this, a movement direction of the lens module 210 may be determined based on the variation regulation of the voltage signal.

It may be understood that in some alternative embodiments, the photoelectric switch 240 is fixed on the lens module 210, and the bevel retaining piece 230 is arranged on the movement path of the lens module 210 and fixedly mounted on the inner wall of the body 100. This may also achieve the same technical effects as the embodiments of the present disclosure.

The control unit 300 includes a controller. The controller includes but is not limited to a general-purpose processor, a digital signal processor (DSP), an application-specific integrated circuit (ASIC), a field-programmable gate array (FPGA), a single-chip microcomputer, or the like.

In the case that the control unit 300 is communicatively connected to the focusing assembly 200, the control unit 300 is communicatively connected to both the photoelectric switch 240 and the motor 220 and configured to receive the current voltage signal from the photoelectric switch 240, determine the current position of the lens module 210 based on the current voltage signal, and control the motor 220 to stop driving the lens module 210 in response to the current position of the lens module 210 being the predetermined position, such that the lens module 210 may be stopped at any real-time position, and thus focusing accuracy of the projector is improved.

It may be understood that in some alternative embodiments, the control unit 300 may be arranged in the focusing assembly 200.

In an embodiment of the present disclosure, the bevel retaining piece is arranged in the focusing assembly to trigger the photoelectric switch to generate the voltage signal, such that the real-time position of the lens module may be determined based on the voltage signal generated by the photoelectric switch, and thus the lens module is controlled based on the voltage signal. In this way, the lens module may be stopped at any real-time position, and thus focusing accuracy is improved.

Referring to FIG. 9, a schematic flowchart of a method for controlling a focusing assembly according to an embodiment of the present disclosure is illustrated. The method for controlling the focusing assembly is applicable to the projector, and is performed by the control unit 300 for improving focusing accuracy of the projector.

Specifically, the method for controlling the focusing assembly includes:

In step S100, a current voltage signal from the photoelectric switch is received.

In step S200, a current position of the lens module is determined based on the current voltage signal.

In an embodiment of the present disclosure, the bevel retaining piece is driven to move relative to the photoelectric switch in the case that the lens module is moving, and in the case that the bevel retaining piece is driven to move in the optical filed of the photoelectric switch, with the change of the position of the bevel retaining piece, the photoelectric switch generates different voltage signals. Therefore, the current position of the lens module may be determined based on the current voltage signal of the photoelectric switch.

Specifically, prior to determining the current position of the lens module based on the current voltage signal from the photoelectric switch, the position of the lens module corresponding to the voltage signals generated by the photoelectric switch is calibrated, and thus a corresponding relationship table between a predetermined voltage signal and a predetermined lens module position is generated. For example, in the case that the position of the bevel retaining piece is s0, the voltage signal of the photoelectric switch is v1; in the case that the position of the bevel retaining piece is s1, the voltage signal of the photoelectric switch is v4; in the case that the position of the bevel retaining piece is s2, the voltage signal of the photoelectric switch is v3; in the case that the position of the bevel retaining piece is s3, the voltage signal of the photoelectric switch is v2; in the case that the position of the bevel retaining piece is s4, the voltage signal of the photoelectric switch is v1; and in the case that the position of the bevel retaining piece is s5, the voltage signal of the photoelectric switch is v1. Since in the case that the position of the bevel retaining piece is s0, s4, or s5, the voltage signals of the photoelectric switch are all v1, in this case, a specific position of the bevel retaining piece may not be determined based on the voltage signal of the photoelectric switch. However, the specific position of the bevel retaining piece may be determined based on the voltage signals v2, v3, and v4. Therefore, the voltage signals v2, v3, and v4 are determined as the predetermined voltage signals, and the corresponding lens module position S1 in the case that the position of the bevel retaining piece is s1, the corresponding lens module position S2 in the case that the position of the bevel retaining piece is s2, and the corresponding lens module position S3 in the case that the position of the bevel retaining piece is s3 are determined as the predetermined lens module positions. The predetermined voltage signal v2 corresponds to the predetermined lens module position S3, the predetermined voltage signal v3 corresponds to the predetermined lens module position S2, and the predetermined voltage signal v4 corresponds to the predetermined lens module position S1.

Based on this, during determination of the current position of the lens module based on the current voltage signal of the photoelectric switch, a predetermined voltage signal matching the current voltage signal is searched in the corresponding relationship table, and the predetermined lens module position corresponding to the predetermined voltage signal matching the current voltage signal is determined as the current position of the lens module. For example, in the case that the current voltage signal of the photoelectric switch is v3, where the predetermined voltage signal matching the current voltage signal v3 has been found in the corresponding relationship table, the predetermined lens module position S2 corresponding to the predetermined voltage signal is determined as the current position of the lens module.

In an embodiment of the present disclosure, the predetermined voltage signal consistent with the current voltage signal is determined as the predetermined voltage signal matching the current voltage signal.

In step S300, whether the current position of the lens module is a predetermined position is determined.

In step S400, the motor is controlled to stop driving the lens module in response to the current position of the lens module being the predetermined position.

In an embodiment of the present disclosure, the predetermined position is a stop position of the lens module for instructing the lens module to stop moving.

The predetermined position may be a target position, or may also be a limit position of the lens module.

In the case that the predetermined position is the target position, the focusing signal is received and the target position carried by the focusing signal is determined as the predetermined position. In this case, when it is determined that the current position of the lens module is the predetermined position, the motor is controlled to stop driving the lens module, that is, the motor is controlled to stop driving the lens module at the target position, such that accurate focusing may be achieved.

The target position is any position of the lens module in the effective stroke.

In the case that the predetermined position is the limit position, since the limit position is a maximum position that lens module is capable of reaching within the effective stroke, and where the movement direction of the lens module varies, the maximum position that the lens module is capable of moving within the effective stroke varies, that is, the limit position varies with the movement direction of the lens module. Therefore, the movement direction of the lens module may be determined, and the predetermined position may be determined based on the movement direction of the lens module.

The movement direction of the lens module includes a first movement direction and a second movement direction, wherein the first movement direction corresponds to a first predetermined limit position, and the second movement direction corresponds to a second predetermined limit position.

Based on this, in response to determining the predetermined position based on the movement direction of the lens module, the first predetermined limit position is determined as the predetermined position in response to the movement direction of the lens module being the first movement direction, or the second predetermined limit position is determined as the predetermined position in response to the movement direction of the lens module being the second movement direction.

The movement direction of the lens module may be determined based on the variation regulation of the voltage signal. The movement direction of the lens module is determined as a first movement direction in response to the variation regulation of the voltage signal indicating that a voltage progressively increases, or the movement direction of the lens module is determined as a second movement direction in response to the variation regulation of the voltage signal indicating that a voltage progressively decreases.

It may be understood that in the case that the predetermined position is the limit position, where it is determined that the current position of the lens module is the predetermined position, the motor is controlled to stop driving the lens module, that is, the motor is controlled to stop driving the lens module at the limit position. Since the limit position is the maximum position that the lens module is capable of reaching within the effective stroke, by controlling the motor to stop driving the lens module at the limit position, the lens module is prevented from touching the wall, thereby improving safety.

The embodiments of the present disclosure provide a method and apparatus for controlling a focusing assembly, a focusing assembly, and a projector. In the method for controlling the focusing assembly, after a current position of a lens module is determined based on a current voltage signal generated by a photoelectric switch under triggering by a bevel retaining piece, whether the current position of the lens module is a predetermined position is determined, and a motor is controlled to stop driving the lens module in response to the current position of the lens module being the predetermined position. In the case that the photoelectric switch is triggered by the bevel retaining piece to generate the voltage signal, since a receive amount of the optical receiver is changed where the bevel retaining piece is in relative movement in the optical field of the photoelectric switch, the voltage signal generated by the photoelectric switch may vary with the change of the position of the bevel retaining piece in the optical field. Based on this, the real-time position of the bevel retaining piece in the optical filed may be determined based on the voltage signal generated by the photoelectric switch under triggering by the bevel retaining piece, and thus the real-time position of the lens module may be determined. On the basis that the real-time position of the lens module may be determined, where the predetermined position is any real-time position of the lens module, whether the lens module reaches the predetermined position is determined based on the current position of the lens module, such that the lens module may be stopped at any real-time position, and thus focusing accuracy is improved.

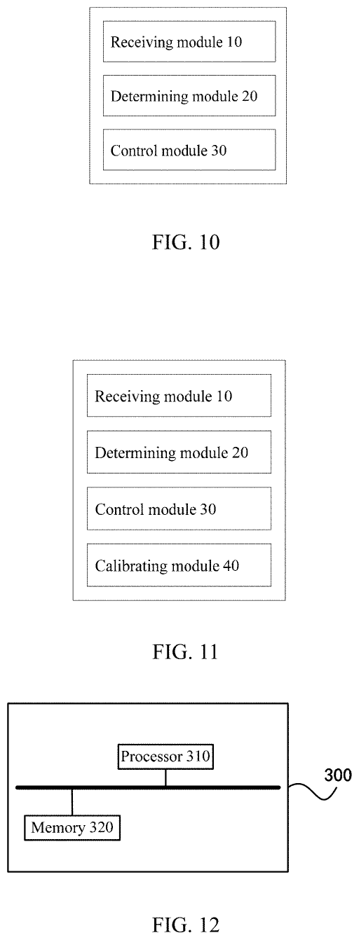

Referring to FIG. 10, a schematic structural diagram of an apparatus for controlling a focusing assembly according to an embodiment of the present disclosure is illustrated. Functions of the modules in the apparatus for controlling the focusing assembly are implemented by the control unit 300 for improving focusing accuracy of the projector.

It should be noted that the term “module” used in the embodiments of the present disclosure is a combination of software and/or hardware that may implement predetermined functions. Although the apparatus described in the embodiments hereinafter may be practiced by software, practice by hardware or a combination of software and hardware may also be conceived.

Specifically, the apparatus for controlling the focusing assembly includes:

a receiving module 10, configured to receive a current voltage signal from the photoelectric switch;

a determining module 20, configured to determine a current position of the lens module based on the current voltage signal, and

determine whether the current position of the lens module is a predetermined position; and

a control module 30, configured to control the motor to stop driving the lens module in response to the current position of the lens module being the predetermined position.

In some embodiments, referring to FIG. 11, the apparatus for controlling the focusing assembly further includes:

a calibrating module 40, configured to pre-calibrate a lens module position corresponding to the voltage signal generated by the photoelectric switch, and generate a corresponding relationship table between a predetermined voltage signal and a predetermined lens module position; and

the determining module 20 is specifically configured to:

search for the predetermined voltage signal matching the current voltage signal in the corresponding relationship table; and

determine a predetermined lens module position corresponding to the predetermined voltage signal matching the current voltage signal as the current position of the lens module.

In some embodiments, the receiving module 10 is further configured to:

receive a focusing signal prior to determining whether the current position of the lens module is a predetermined position, wherein the focusing signal carries a target position; and

determine the target position as the predetermined position.

In some embodiments, the determining module 20 is further configured to:

determine a movement direction of the lens module prior to determining whether the current position of the lens module is the predetermined position; and

determine the predetermined position based on the movement direction of the lens module.

In some embodiments, the determining module 20 is specifically configured to:

determine a variation regulation of the voltage signal; and

determine the movement direction of the lens module as a first movement direction in response to the variation regulation of the voltage signal indicating that a voltage progressively increases, or

determine the movement direction of the lens module as a second movement direction in response to the variation regulation of the voltage signal indicating that a voltage progressively decreases.

In some embodiments, the first movement direction corresponds to a first predetermined limit position, and the second movement direction corresponds to a second predetermined limit position; and

the determining module 20 is specifically configured to:

determine the first predetermined limit position as the predetermined position in response to the movement direction of the lens module being the first movement direction, or

determine the second predetermined limit position as the predetermined position in response to the movement direction of the lens module being the second movement direction.

Since the apparatus embodiments are based on the same inventive concept as the method embodiments, in the case of no conflict of the content, the content of the apparatus embodiments may be referenced to that of the method embodiment, which is not described herein any further.

In some other alternative embodiments, the receiving module 10, the determining module 20, the control module 30, and the calibrating module 40 may be processing chips of the control unit 300.

The embodiments of the present disclosure provide a method and apparatus for controlling a focusing assembly, a focusing assembly, and a projector. In the method for controlling the focusing assembly, after a current position of a lens module is determined based on a current voltage signal generated by a photoelectric switch under triggering by a bevel retaining piece, whether the current position of the lens module is a predetermined position is determined, and a motor is controlled to stop driving the lens module in response to the current position of the lens module being the predetermined position. In the case that the photoelectric switch is triggered by the bevel retaining piece to generate the voltage signal, since a receive amount of the optical receiver is changed where the bevel retaining piece is in relative movement in the optical field of the photoelectric switch, the voltage signal generated by the photoelectric switch may vary with the change of the position of the bevel retaining piece in the optical field. Based on this, the real-time position of the bevel retaining piece in the optical filed may be determined based on the voltage signal generated by the photoelectric switch under triggering by the bevel retaining piece, and thus the real-time position of the lens module may be determined. On the basis that the real-time position of the lens module may be determined, where the predetermined position is any real-time position of the lens module, whether the lens module reaches the predetermined position is determined based on the current position of the lens module, such that the lens module may be stopped at any real-time position, and thus focusing accuracy is improved.

Referring to FIG. 12, a schematic hardware structural diagram of a control unit 300 according to an embodiment of the present disclosure is illustrated.

As illustrated in FIG. 12, the controller unit 300 includes one or more processors 310, and a memory 320. FIG. 12 uses one processor 310 as an example.

The processor 310 and the memory 320 may be connected via a bus or in another manner, and FIG. 12 uses the bus as an example.

The memory 320, as a non-volatile computer readable storage medium, may be configured to store non-volatile software programs, non-volatile computer executable programs and modules, for example, the program instructions corresponding to the method for controlling the focusing assembly, and the modules corresponding to the apparatus for controlling the focusing assembly in the embodiments of the present disclosure (for example, the receiving module 10, the determining module 20, the control module 30, and the calibrating module 40, and the like). The non-volatile software programs, instructions and modules stored in the memory 320, when executed, cause the at least one processor 310 to perform various function applications and data processing of the method for controlling the focusing assembly, that is, performing the method for controlling the focusing assembly in the above method embodiments and implementing the functions of the modules in the above apparatus embodiments.

The memory 320 may include a program memory area and data memory area, wherein the program memory area may store operation systems and application programs needed by at least function; and the data memory area may store data created according to the usage of the apparatus for controlling the focusing assembly.

The data memory area also stores predetermined data, wherein the predetermined data includes the predetermined position, the corresponding relationship table between the predetermined voltage signal and the predetermined lens module position, the first predetermined limit position, the second predetermined limit position, and the like.

In addition, the memory 320 may include a high-speed random access memory, or include a non-volatile memory, for example, at least one disk storage device, a flash memory device, or another non-volatile solid storage device. In some embodiments, the memory 320 optionally includes memories remotely configured relative to the processor 310. These memories may be connected to the processor 310 over a network. Examples of the above network include, but not limited to, the Internet, Intranet, local area network, mobile communication network and a combination thereof.

The program instructions and the one or more modules are stored in the memory 320, which, when executed by the one or more processors 310, cause the one or more processors 310 to perform the steps in the method for controlling the focusing assembly in any of the above method embodiments, or implement the functions of the modules in the apparatus for controlling the focusing assembly in any of the above apparatus embodiments.

The product may perform the method according to the embodiments of the present disclosure, has corresponding function modules for performing the method, and achieves the corresponding beneficial effects. For technical details that are not illustrated in detail in this embodiment, reference may be made to the description of the methods according to the embodiments of the present disclosure.

An embodiment of the present disclosure further provides a non-volatile computer-readable storage medium. The non-volatile computer-readable storage medium stores one or more computer-executable instructions, which, when executed by one or more processors, for example, the processor 310 as illustrated in FIG. 12, cause the one or more processors to perform the steps in the method for controlling the focusing assembly in any of the above method embodiments, or implement the functions of the modules in the apparatus for controlling the focusing assembly in any of the above apparatus embodiments.

An embodiment of the present disclosure further provides a computer program product. The computer program product includes one or more computer programs stored in a non-volatile computer-readable storage medium. The one or more computer programs include one or more program instructions, which, when executed by one or more processors, for example, the processor 310 as illustrated in FIG. 12, cause the one or more processors to perform the steps in the method for controlling the focusing assembly in any of the above method embodiments, or implement the functions of the modules in the apparatus for controlling the focusing assembly in any of the above apparatus embodiments.

The above described apparatus embodiments are merely for illustration purpose only. The modules which are described as separate components may be physically separated or may be not physically separated, and the components which are illustrated as modules may be or may not be physical units, that is, the components may be located in the same position or may be distributed into a plurality of network units. Part or all of the modules may be selected according to the actual needs to achieve the objects of the technical solutions of the embodiments.

According to the above embodiments of the present disclosure, a person skilled in the art may clearly understand that the embodiments of the present disclosure may be implemented by means of hardware or by means of software plus a necessary general hardware platform. Persons of ordinary skill in the art may understand that all or part of the steps of the methods in the embodiments may be implemented by a program instructing relevant hardware. The program may be stored in a computer readable storage medium and may be executed by at least one processor. When the program runs, the steps of the methods in the embodiments are performed. The storage medium may be a read-only memory (ROM), a random-access memory (RAM), a magnetic disk, or a compact disc read-only memory (CD-ROM).

Described above are exemplary embodiments of the present disclosure, but are not intended to limit the scope of the present disclosure. Any equivalent structure or equivalent process variation made based on the specification and drawings of the present disclosure, which is directly or indirectly applied in other related technical fields, fall within the scope of the present disclosure.

Finally, it should be noted that the above embodiments are merely used to illustrate the technical solutions of the present disclosure rather than limiting the technical solutions of the present disclosure. Under the concept of the present disclosure, the technical features of the above embodiments or other different embodiments may be combined, the steps therein may be performed in any sequence, and various variations may be derived in different aspects of the present disclosure, which are not detailed herein for brevity of description. Although the present disclosure is described in detail with reference to the above embodiments, persons of ordinary skill in the art should understand that they may still make modifications to the technical solutions described in the above embodiments, or make equivalent replacements to some of the technical features; however, such modifications or replacements do not cause the essence of the corresponding technical solutions to depart from the spirit and scope of the technical solutions of the embodiments of the present disclosure.

What is claimed is:

1. A method for controlling a focusing assembly, wherein the focusing assembly comprises a lens module, a motor, a bevel retaining piece, and a photoelectric switch, the photoelectric switch comprising an optical transmitter and an optical receiver, the optical transmitter and the optical receiver being oppositely disposed, the motor being connected to the lens module and configured to drive the lens module to move, the bevel retaining piece being in movement relative to the photoelectric switch in the case that the lens module is moving, wherein an optical field between the optical transmitter and the optical receiver is positioned on a relative movement path of the bevel retaining piece, and in the case that the bevel retaining piece is moving in the optical field, the bevel retaining piece changes a receive amount of the optical receiver, and the photoelectric switch generates a voltage signal based on the receive amount; and
the method comprises:
receiving a current voltage signal from the photoelectric switch;
determining a current position of the lens module based on the current voltage signal;
determining whether the current position of the lens module is a predetermined position; and
controlling the motor to stop driving the lens module in response to the current position of the lens module being the predetermined position.

2. The method according to claim 1, further comprising:
pre-calibrating a lens module position corresponding to the voltage signal generated by the photoelectric switch, and generating a corresponding relationship table between a predetermined voltage signal and a predetermined lens module position;
wherein determining the current position of the lens module based on the current voltage signal specifically comprises:
searching for the predetermined voltage signal matching the current voltage signal in the corresponding relationship table; and
determining a predetermined lens module position corresponding to the predetermined voltage signal matching the current voltage signal as the current position of the lens module.

3. The method according to claim 1, wherein prior to determining whether the current position of the lens module is the predetermined position, the method further comprises:
receiving a focusing signal, wherein the focusing signal carries a target position; and
determining the target position as the predetermined position.

4. The method according to claim 1, wherein prior to determining whether the current position of the lens module is the predetermined position, the method further comprises:
determining a movement direction of the lens module; and
determining the predetermined position based on the movement direction of the lens module.

5. The method according to claim 4, wherein determining the movement direction of the lens module specifically comprises:
determining a variation regulation of the voltage signal; and
determining the movement direction of the lens module as a first movement direction in response to the variation regulation of the voltage signal indicating that a voltage progressively increases, or
determining the movement direction of the lens module as a second movement direction in response to the variation regulation of the voltage signal indicating that a voltage progressively decreases.

6. The method according to claim 5, wherein the first movement direction corresponds to a first predetermined limit position, and the second movement direction corresponds to a second predetermined limit position; and
determining the predetermined position based on the movement direction of the lens module specifically comprises:
determining the first predetermined limit position as the predetermined position in response to the movement direction of the lens module being the first movement direction, or
determining the second predetermined limit position as the predetermined position in response to the movement direction of the lens module being the second movement direction.

7. A focusing assembly, comprising:
a lens module;
a bevel retaining piece;
a photoelectric switch, wherein the photoelectric switch comprises an optical transmitter and an optical receiver, the optical transmitter and the optical receiver being oppositely disposed; and
a motor, wherein the motor is connected to the lens module and configured to drive the lens module to move, and the bevel retaining piece is in movement relative to the photoelectric switch in the case that the lens module is moving, wherein an optical field between the optical transmitter and the optical receiver is positioned on a relative movement path of the bevel retaining piece, and in the case that the bevel retaining piece is moving in the optical field, the bevel retaining piece changes a receive amount of the optical receiver, and the photoelectric switch generates a voltage signal based on the receive amount.

8. A projector, comprising:
the focusing assembly as defined in claim 7; and
a control unit, wherein the control unit is connected to the focusing assembly;
wherein the control unit comprises at least one processor, and
a memory communicably connected to the at least one processor;
wherein the memory is configured to store at least one instruction executable by the at least one processor, wherein the at least one instruction, when executed by the at least one processor, causes the at least one processor to
receiving a current voltage signal from the photoelectric switch;
determining a current position of the lens module based on the current voltage signal;
determining whether the current position of the lens module is a predetermined position; and
controlling the motor to stop driving the lens module in response to the current position of the lens module being the predetermined position.

9. The projector according to claim 8, wherein the at least one instruction, when executed by the at least one processor, causes the at least one processor to
pre-calibrating a lens module position corresponding to the voltage signal generated by the photoelectric switch, and generating a corresponding relationship table between a predetermined voltage signal and a predetermined lens module position;
wherein determining the current position of the lens module based on the current voltage signal specifically comprises:
searching for the predetermined voltage signal matching the current voltage signal in the corresponding relationship table; and
determining a predetermined lens module position corresponding to the predetermined voltage signal matching the current voltage signal as the current position of the lens module.

10. The projector according to claim 8, wherein the at least one instruction, when executed by the at least one processor, causes the at least one processor to
prior to determining whether the current position of the lens module is the predetermined position, receiving a focusing signal, wherein the focusing signal carries a target position; and
determining the target position as the predetermined position.

11. The projector according to claim 8, wherein the at least one instruction, when executed by the at least one processor, causes the at least one processor to
prior to determining whether the current position of the lens module is the predetermined position, determining a movement direction of the lens module; and
determining the predetermined position based on the movement direction of the lens module.

12. The projector according to claim 11, wherein determining the movement direction of the lens module specifically comprises:
determining a variation regulation of the voltage signal; and
determining the movement direction of the lens module as a first movement direction in response to the variation regulation of the voltage signal indicating that a voltage progressively increases, or
determining the movement direction of the lens module as a second movement direction in response to the variation regulation of the voltage signal indicating that a voltage progressively decreases.

13. The projector according to claim 12, wherein the first movement direction corresponds to a first predetermined limit position, and the second movement direction corresponds to a second predetermined limit position; and
determining the predetermined position based on the movement direction of the lens module specifically comprises:
determining the first predetermined limit position as the predetermined position in response to the movement direction of the lens module being the first movement direction, or
determining the second predetermined limit position as the predetermined position in response to the movement direction of the lens module being the second movement direction.

14. A non-transitory computer-readable storage medium, wherein the computer-readable storage medium stores at least one computer-executable instruction, wherein the at least one computer-executable instruction, when executed by a computer, causes the computer to
receiving a current voltage signal from the photoelectric switch;
determining a current position of the lens module based on the current voltage signal;
determining whether the current position of the lens module is a predetermined position; and
controlling the motor to stop driving the lens module in response to the current position of the lens module being the predetermined position.

15. The non-transitory computer-readable storage medium according to claim 14, wherein the at least one computer-executable instruction, when executed by a computer, causes the computer to
pre-calibrating a lens module position corresponding to the voltage signal generated by the photoelectric switch, and generating a corresponding relationship table between a predetermined voltage signal and a predetermined lens module position;
wherein determining the current position of the lens module based on the current voltage signal specifically comprises:
searching for the predetermined voltage signal matching the current voltage signal in the corresponding relationship table; and
determining a predetermined lens module position corresponding to the predetermined voltage signal matching the current voltage signal as the current position of the lens module.

16. The non-transitory computer-readable storage medium according to claim 14, wherein the at least one computer-executable instruction, when executed by a computer, causes the computer to
prior to determining whether the current position of the lens module is the predetermined position, receiving a focusing signal, wherein the focusing signal carries a target position; and
determining the target position as the predetermined position.

17. The non-transitory computer-readable storage medium according to claim 14, wherein the at least one computer-executable instruction, when executed by a computer, causes the computer to
prior to determining whether the current position of the lens module is the predetermined position, determining a movement direction of the lens module; and
determining the predetermined position based on the movement direction of the lens module.

18. The non-transitory computer-readable storage medium according to claim 17,
wherein determining the movement direction of the lens module specifically comprises:
determining a variation regulation of the voltage signal; and
determining the movement direction of the lens module as a first movement direction in response to the variation regulation of the voltage signal indicating that a voltage progressively increases, or
determining the movement direction of the lens module as a second movement direction in response to the variation regulation of the voltage signal indicating that a voltage progressively decreases.

19. The non-transitory computer-readable storage medium according to claim 18, wherein the first movement direction corresponds to a first predetermined limit position, and the second movement direction corresponds to a second predetermined limit position; and
determining the predetermined position based on the movement direction of the lens module specifically comprises:
determining the first predetermined limit position as the predetermined position in response to the movement direction of the lens module being the first movement direction, or
determining the second predetermined limit position as the predetermined position in response to the movement direction of the lens module being the second movement direction.
